(19) United States
(12) Patent Application Publication
(10) Pub. No.: US 2026/0228684 A1
(43) Pub. Date: Aug. 6, 2026

(54) METHODS AND DEVICES FOR GROUPING AND TRACING OBJECTS

(71) Applicant: EDGYN, Paris (FR)

(72) Inventors: Hervé DU DOIGNON, La Motte Servolex (FR); Camille DISS, Paris (FR); Sébastien BECHET, Aix les bains (FR)

(21) Appl. No.: 19/153,062

(22) PCT Filed: Feb. 2, 2024
(86) PCT No.: PCT/FR2024/050136

§ 371 Date: Aug. 1, 2025

(30) Foreign Application Priority Data
Feb. 2, 2023 (FR) FR2300979

(51) Int. Cl. G06Q 10/087

(52) U.S. Cl. CPC G06Q 10/087

(57) ABSTRACT

Methods, systems, and devices for grouping and tracking a plurality of objects. The disclosure includes steps or operations that include: acquiring (E60) at least one image (IMGi), at least one region of a surface (RSi) of each of the objects being represented in the at least one image; processing (E70) the image(s) to obtain, for each of the objects, a digital signature (SIGOi) for each object (OBJi) based on the surface region (RSi) of each object; obtaining (E80) a unique identifier (IDCONT) for the grouping unit; obtaining (E90), for each (OBJi) of the objects, a datum (INDi, INFOOi) associated with each object in a first memory (BD1) based on the digital signature (SIGOi) of each object; and associating (E100), in a second memory (BD2), the datum (INDi, INFOOi) and/or the digital signature (SIGOi) associated with each object (OBJi) with the unique identifier (IDCONT) of the grouping unit (CONT).

### BACKGROUND OF THE INVENTION

The invention relates to the field of object tracking.

It is recalled that the issue of object tracking generally concerns the collecting and providing of information making it possible to track an object at different times in its life, for example along its production, transformation or distribution chain.

Traditionally, object tracking is set up by assigning a unique identifier to each object and by re-reading this identifier at different steps of the production or distribution process to ensure the tracking of this object.

Currently, the most common formats used to assign a unique identifier to an object are printed visible codes (e.g. in 1D format, of Code 39 or Code 128 type, or in 2D format, of QR code or Data Matrix type) or electronic chips containing a unique identifier in their memory (RFID).

To set up unit object tracking it is necessary to manage the identification and tracking of each object, of each level of object grouping (e.g. Packaging, boxes, pallets etc.) and also record the link between each object and its higher grouping (or conditioning) level, a function commonly known as aggregation.

In practice this may consist, at the time of grouping of several objects into a higher grouping unit, in reading the unit identifier of each of the objects (which often takes the form of a visible unit code printed on each of the objects), generating a unit identifier for the higher grouping unit and associating, in the memory in a management system, all the unit identifiers of the objects contained in the higher conditioning unit with the unit identifier of the higher conditioning unit.

This step of the tracking process may encounter heavy operational restrictions such as:
the impossibility of affixing a visible identifier on an area which can be re-read at the time of aggregation, for example because the printing of an ink-based visible mark is impossible on the visible areas at the time of aggregation;
difficulties in re-reading the identifiers of the objects at the time of their grouping into a higher unit, because the set of visible codes of the objects are not accessible to a re-reading system at the time of aggregation. This is for example the case of bottles, the visible code of which is inscribed on the label and which is not therefore visible on the conditioned bottle standing up in conditioning such as a box, or for perfume packaging, the code of which is on the bottom of the box and is not visible once the packaging is put vertically in a grouping box;
restrictions related to the printing of a visible code on the cork of a bottle, the only visible part on the set of bottles at the time of boxing; when the surface of the cork is used for the logo of the brand, the latter not being able to be replaced by a code with a technical purpose,
restrictions related to the printing of a visible code on the top of a drink can (difficulty finding edible inks of sufficient durability and/or obtaining adequate contrast allowing for a satisfactory rate of re-reading of the code by a camera)
restrictions related to the printing and re-reading of an invisible code. In this case, the restriction comes from the fact that the re-reading of an invisible ink reactive to UV/IR or in a specific wavelength is made difficult by the variability of the substrates and the background colors of the support on which the invisible code is printed with moreover, for cans, the edibility restrictions mentioned above.

The invention described here has the aim of removing these restrictions and allowing a more widespread adoption of object unit tracking solutions which makes it possible to dispense with or complement the use of visible unit codes.

### SUBJECT AND SUMMARY OF THE INVENTION

Thus, and according to a first aspect, the invention relates to a method for grouping a plurality of objects into a grouping unit, said method including the following steps:
acquiring at least one image, at least one region of a surface of each of said objects being represented in at least one said image;
processing said at least one image to obtain, for each of said objects, a digital signature for this object based on said surface region of this object;
obtaining a unique identifier for said grouping unit;
obtaining, for each of said objects, a datum associated with this object in a first memory based on the digital signature of this object; and
associating, in a second memory, the datum and/or the digital signature associated with each object with the unique identifier of said grouping unit.

Correspondingly, the invention relates to a system for grouping a plurality of objects into a grouping unit, said system including:
a module for acquiring at least one image, at least one region of a surface of each of said objects being represented in at least one said image;
a module for processing said at least one image to obtain, for each of said objects, a digital signature for this object based on said surface region of this object;
a module for obtaining a unique identifier for said grouping unit;
a module for obtaining, for each of said objects, a datum associated with this object in a first memory based on the digital signature of this object; and
a module for associating, in a second memory, the datum and/or digital signature associated with each object with the unique identifier of said grouping unit.

According to a second aspect, the invention also concerns a method for tracking at least one object, said method including the following steps:
obtaining an item of information associated with this object or a digital signature for this object based on a surface region of this object;
obtaining, in a second memory filled by the associating step of a grouping method as mentioned above, an identifier of a grouping unit associated with said item of information associated with this object and/or with the digital signature for this object; and
tracking said grouping unit.

In this document, the obtaining of a unique identifier for the grouping unit may consist in the generating of this identifier.

In this document, a module denotes:
a software module, for example a program, a function or a computer library; or
a hardware module in the form of one or more components.

At least certain modules of the grouping system may be implemented within one and the same component.

In a particular embodiment, the tracking method further including the following steps:
acquiring at least one image representing at least one region of a surface of said object; and
processing said at least one image to obtain the digital signature representative of this object based on said region of the surface of this object represented in said at least one image.

Correspondingly, the invention also relates to a system for tracking at least one object, said system including:
a module for obtaining an item of information associated with this object and/or a module for obtaining a digital signature for this object based on a surface region of this object;
a module for obtaining, in a memory filled by the associating step of a grouping method as mentioned above, an identifier of a grouping unit associated with said item of information associated with this object and/or with the digital signature for this object; and
a module for tracking said grouping unit.

Thus, the invention in particular makes provision for associating with each object a digital signature obtained by processing an image representing a region of a surface of this object. This digital signature is thus obtained based on visible random characteristics on this object, whether they are pre-printed elements or visible random characteristics related to the very material of the object. Very advantageously, the obtaining of the digital signature does not require the adding or printing of an item of information on the object.

The invention makes it possible to perform the matching between the items of information of the objects and the unique identifier of the grouping unit and therefore to ensure the tracking of the objects during their conditioning in a way that does not involve the printing of a visible code or any other intrusive technology on these products.

The solution makes it possible to identify an object on a unit basis by replicating the same process as at the recording (capture of an image, generation of a digital signature) and by comparing the digital signature thus generated to the digital signatures previously recorded. The object is identified when the digital signature generated on the re-reading is identical or sufficiently similar to the digital signature generated on recording.

The means for acquiring images and generating digital signatures are chosen with:
a high enough discrimination rate to ensure that two different objects have two different digital signatures; and
a high replication rate to ensure that two generations of digital signatures based on one and the same object will result in identical digital signatures or digital signatures which are similar enough to allow the identification of the object.

In an embodiment of the invention, a method is used for extracting random digital signatures of a material element as described in the document WO 2007/071788A1. This method makes it possible to effectively guarantee the uniqueness of the digital signature such as to be sure that two distinct material elements will have two different digital signatures and will be recognized individually with no risk of confusion. It more specifically proposes to extract the digital signature based on structural features of the object material element, for example based on internal and/or external geometrical or morphological features, where applicable associated with features of chemical or physico-chemical composition, color, structure or other, related to their location in space on the object material element.

In another embodiment of the invention, the digital signatures are computed based on the image of a structural element of the object which presents one or more complex features, chaotic and (quasi-invariant over time). Such a method is described in document EP1716520.

In another embodiment, the digital signatures are generated based on a structural feature extracted from a reference area of a fiber support of the object, for example made of paper, cardboard or non-woven, the digital signature rendering the fiber structure of this reference area. Such a method is described in document EP1747540.

The unit nature of the generated digital signature is a result of the nature, specific to each object, of the visible random characteristics on that object with a sufficient level of optical resolution, random characteristics related to the intrinsic composition of the material (surface relief of the structure of the material for example) or to the random characteristics related to the surface treatment on the object (printing, coating etc.) and to the image processing algorithms to extract a unique digital identifier therefrom.

The generation of the identifier of the object can thus be performed based on the surface of the product that is the most appropriate with regard to the operational process in the logistical chain, i.e. the visible surface just before or just after the aggregating step, and makes it possible to thus dispense with the operational restrictions set out above.

Specifically, in an embodiment, for at least one of said objects, the region of the surface of the object which is used for the generation of the digital signature is a region that is visible when the object is in the grouping unit.

The grouping unit is for example a container, a box, a pallet, any type of conditioning unit, a flexible packaging, for example a stretch film, an item of transportation equipment or an area for the storage of the objects.

In a particular embodiment, the datum associated with an object is an identifier of this object, or an index making it possible to access identification data of the object in the first database.

In another embodiment, the datum associated with an object is an item of information associated with this object, said method further including, for each of said objects, the following steps:
obtaining the item of information associated with this object; and
recording this item of information in association with the digital signature of this object in the first memory.

In a particular embodiment, for at least one object, the item of information associated with this object is present on said object, or accessible by a code, for example a QR code or by a link present on the object.

For example, the item of information associated with an object is a unique identifier associated with this object, for example an alphanumeric code, a bar code with one or more dimensions, a QR code or a Data Matrix.

In a particular embodiment, for at least one object, the item of information associated with this object and present on this object is at least partially masked by said grouping unit.

For example, if the item of information associated with a bottle is a code printed on the bottom part of the bottle, for example on the back-label, this is no longer visible when the bottle is placed vertically in a box. The invention makes it possible to restore this item of information based on a digital signature generated based on a surface region on the top part of the bottle without removing the bottle from the box, and without inscribing any new codes on the bottle.

The invention also makes it possible to recover these items of information based on the unique identifier of the grouping unit.

The first and second memories may be distinct databases, or even one and the same database.

In a particular embodiment, the different steps of the methods for grouping objects and tracking are determined by instructions of computer programs or are implemented by a silicon chip which comprises integrated or programmable components suitable for constituting logic gates of a non-programmable wired logic, or even on quantum computers.

Consequently, the invention also relates to a computer program on an information medium, this program being able to be implemented in a controller computer, this program including instructions suitable for implementing the steps of a method as described above.

This program can use any programming language, and be in the form of source code, object code, or intermediate code between source code and object code, such as in a partially compiled form, or in any other desirable form.

The invention also concerns an information medium readable by a computer, and including instructions of a computer program as mentioned above. The information medium can be any entity or device capable of storing the program. Consequently, for example, the medium can include a storage means, such as a ROM, a non-volatile memory of flash type or else a magnetic recording means, for example a hard disk. Moreover, the information medium can be a transmissible medium such as an electrical or optical signal, which can be conveyed via an electrical or optical cable, by radio or by other means. The program according to the invention can in particular be downloaded over a network of Internet type. Alternatively, the information medium can be an integrated circuit into which the program is incorporated, the circuit being suitable for executing or for being used in the execution of the method in question.

### BRIEF DESCRIPTION OF THE DRAWINGS:

Other features and advantages of this invention will become apparent from the description given below, with reference to the appended drawings which illustrate exemplary embodiments thereof without any limitation. On the figures:

FIG. 1 shows an operator obtaining items of information relating to an object in accordance with an aspect of the invention in a particular embodiment;

FIG. 2 shows the operation of FIG. 1 performed automatically, without the involvement of the operator;

FIG. 3 shows, in its environment, the functional architecture of a user device and of a tracking system which can be used in a particular embodiment of the invention;

FIG. 4 shows the main steps of a grouping method in accordance with a particular embodiment;

FIG. 5 illustrates an image of a region of the surface of an object;

FIG. 6 illustrates a first database which can be used in a particular embodiment of the invention;

FIG. 7 illustrates the steps of a method for grouping objects in accordance with a particular embodiment of the invention;

FIG. 8 illustrates a second database which can be used in a particular embodiment of the invention;

FIG. 9 illustrates a database grouping the first and second databases of FIGS. 6 and 8;

FIG. 10 shows the main steps of a method for tracking an object in accordance with a particular embodiment of the invention;

FIG. 11 shows the hardware architecture of a tracking system in accordance with a particular embodiment of the invention; and

FIG. 12 shows the hardware architecture of the user device of FIG. 3.

### DESCRIPTION OF EMBODIMENTS OF THE INVENTION

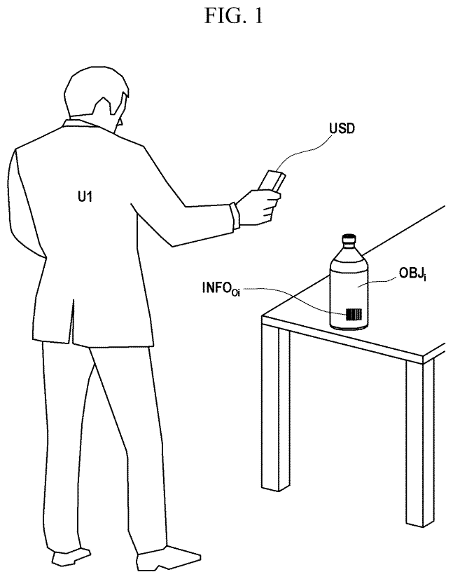

FIG. 1 shows an operator U1 implementing certain steps of a method for grouping objects in accordance with a first embodiment of the invention.

In the example described here, it is assumed that the operator U1 records, in a first database BD1 (first memory within the meaning of the invention) items of information relating to bottles OBJᵢ (objects within the meaning of the invention) intended to be subsequently grouped into a box (grouping unit within the meaning of the invention).

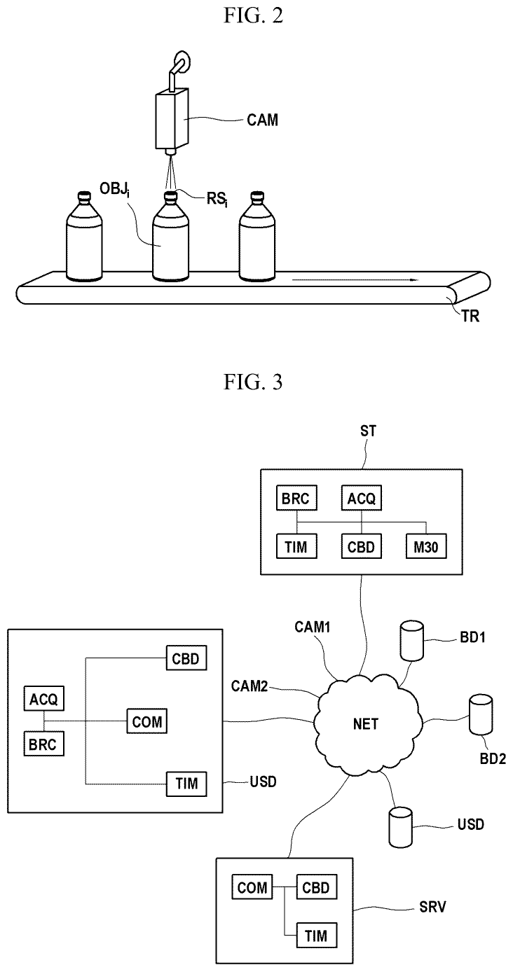

Alternatively, the bottles OBJᵢ are moved along a conveyer belt TR and an optical control system CAM scans the bottles on which the items of information are indicated and records them in the database BD1. In this particular embodiment, and as shown on FIG. 2, the user device USD is replaced by an acquiring system disposed on the production line and which comprises identical or equivalent elements to those of the device USD described hereinafter with reference to FIG. 3.

The objects may take the form of packaging, or other products made of any materials such as glass, metal, plastic etc.

In this embodiment, each bottle has an item of information INFO_{Oi}, consisting in this example in a bar code, present, for example, on the bottom part of the bottle, for example on the back-label. The item of information INFO_{Oi} can also be etched directly on the object. It may further comprise an item of information relating to the date, time, a production line identifier, a batch number, a production center etc.

In the embodiment described here, the operator U1 is equipped with a user device USD, typically a smartphone.

In the embodiment shown in FIG. 3, this user device USD includes:
an information-acquiring module BRC including hardware and software means, for example a scanner, making it possible to read a bar code INFO_{Oi} present on a bottle OBJᵢ and for example a QR Code ID_{CONT} present on a box CONT;
an image-acquiring module ACQ including hardware and software means making it possible to acquire an image of a bottle OBJᵢ, for example a camera;
an image-processing module TIM configured to process an image representing a surface region of an object OBJᵢ and obtain a digital signature for this object based on this surface region;
a software client CBD configured to access databases and particularly to read or write items of information in the databases BD1 and BD2 described hereinafter;
a communication module COM allowing the device to communicate over the network NET.

The user device USD includes a communication module COM to communicate over a network NET. In the example of FIG. 3, the following are also connected to this network: other user devices USD, a server SRV, cameras CAM1, CAM2, the database BD1 and a second database BD2 (second memory within the meaning of the invention) and a tracking system ST in accordance with an embodiment of the invention.

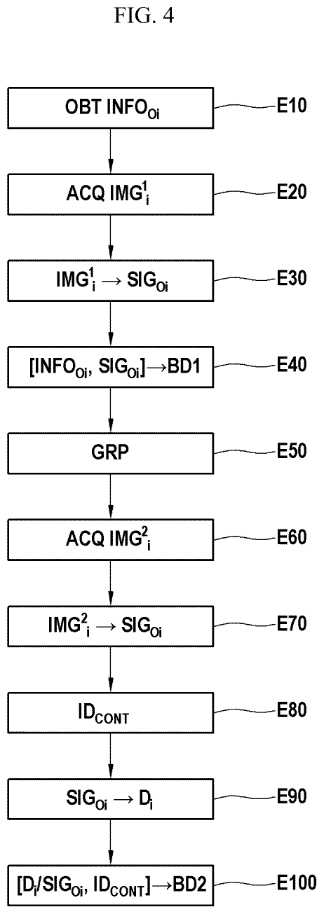

FIG. 4 shows, in the form of a flow chart, the main steps of a grouping method in accordance with a particular embodiment of the invention.

In this embodiment, the operator U1 obtains, for each bottle OBJᵢ intended to be stored in a box CONT:
the bar code INFO_{Oi} present on the bottom part of the bottle using the information-acquiring module BRC of its device USD (step E10); and
a first image IMG¹ᵢ representing a region RSᵢ of the surface of this object using the image-acquiring module ACQ of its device USD (step E20).

In the embodiment previously described, the steps E10 and E20 are shown as implemented one after the other, i.e. successively.

In a variant, the steps E10 and E20 are implemented simultaneously (or substantially simultaneously).

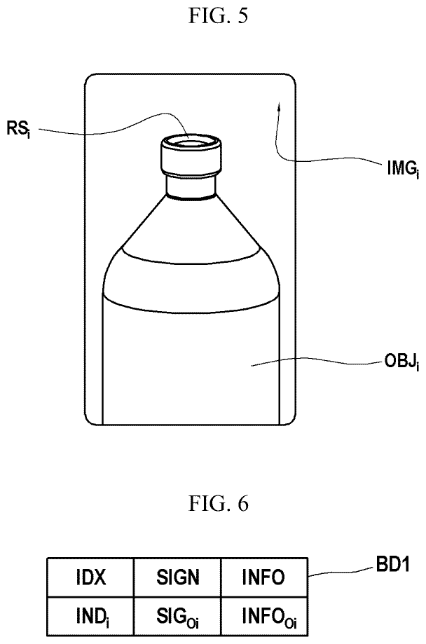

FIG. 5 illustrates such an image IMG¹ᵢ in which the surface region RSi is situated on the upper part of the bottle OBJᵢ, for example at the cork, preferably on the top of the cork when the bottle is disposed upright.

In the embodiment described here, the first image IMG¹ᵢ acquired (in the step E20) for an object OBJᵢ is processed during a step E30 to obtain a digital signature SIG_{Oi} for this object OBJᵢ based on the surface region RSᵢ of this object.

This digital signature is for example representative of the material, texture or color of the surface region RS of the object OBJᵢ. The digital signature is for example computed based on the image of a structural element of the region RSᵢ which has one or more complex, chaotic features and (quasi-invariant over time) according to the method described in document EP1716520.

In the embodiment described here, this image processing (step E30) is done by the user device USD of the user U1. In a preferred variant, the images can be sent to the server SRV by the network NET, processed by this server SRV to obtain the digital signatures, the server storing the digital signatures SIG_{Oi} and optionally sends them back to the user device USD. In another variant, the images are processed by the user device USD to obtain the digital signatures which are stored on the user device USD, at least temporarily, and optionally sent to the server SRV.

For this purpose, in the embodiment described here and as shown in FIG. 3, the server SRV includes:
an image processing module TIM;
a software client CBD configured to access databases; and
a communication module COM
identical or similar to those of the user device USD.

In the embodiment described here, during a step E40, the information INFO_{Oi} associated with an object (in this example the bar code) is recorded in association with the digital signature SIG_{Oi} computed for this object OBJ, in the first database BD1. An example of such a first database is shown in FIG. 6. In this example, each record (row of the database) includes:
an index INDᵢ of the recording in a field IDENTIFIER;
a digital signature SIG_{Oi} in a digital signature field SIGN; and
an item of information INFO_{Oi} associated with this object in a field INFO.

In the embodiment described here, this recording is made by the user device USD of the user U1. In a variant, the user device USD sends to the server SRV, for example at the same time as the image IMG¹ᵢ of an object, the item of information INFO_{Oi} associated with this object, and the recording in the database BD1 (step E40) is performed by the server SRV.

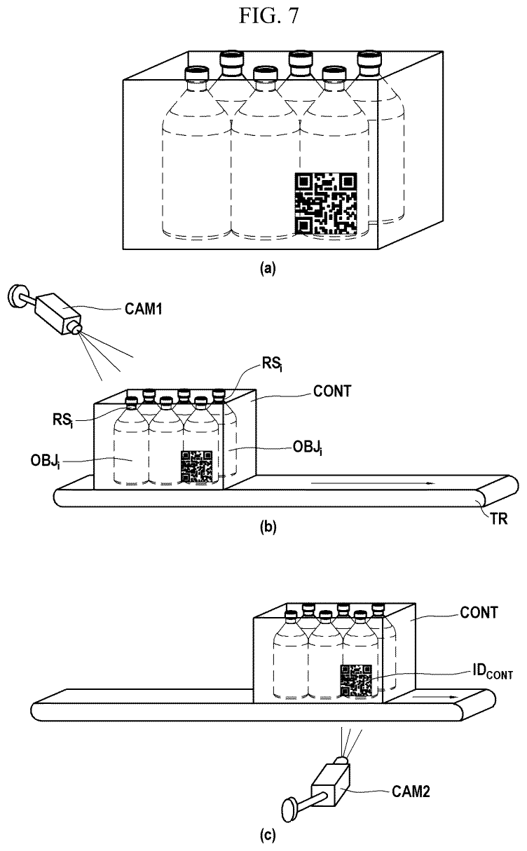

FIG. 7 illustrates other steps of the method for grouping objects in accordance with at least this first embodiment of the invention.

As illustrated in FIG. 7(a), it is assumed that during a step E50, the bottles OBJᵢ are grouped into a box CONT (grouping unit). This box includes a unique identifier ID_{CONT}consisting in this example in a QR Code. This grouping (or storage) can be carried out by the operator U1, by another operator, by a machine (boxing machine, palletizer) or by a robot.

During a step E60, illustrated in FIG. 7(b), one acquires at least a second image IMG²ᵢ, the region RSᵢ of the surface of each of the grouped objects OBJᵢ in the box CONT being represented in this at least one second image.

In the embodiment of FIG. 7(b), a camera CAM1 takes a single image IMG²ᵢ including the region RSᵢ of each of the bottles OBJᵢ grouped into the box. This image may be acquired while the box CONT travels past on a conveyor belt TR in the field of the camera CAM1.

In practice, the solution for capturing the images can operate at a working distance greater than 13 cm which makes it possible to scan each of the products even though the box is open, without the captures being hindered by the flaps of the box CONT.

In a variant, the operator U1 (or another operator) uses a user device USD to take, for each bottle OBJ grouped into the box, a second image IMG²ᵢ representing the surface region RSᵢ of this bottle OBJᵢ. Alternatively, the operator takes a single image IMG²ᵢ including the region RSᵢ of each of the bottles OBJ grouped into the box CONT.

The acquiring of the second image or images IMG²ᵢ can be done after the bottles are put in the box CONT, or just before when the destination box CONT is known, or while they are grouped.

During a step E70, the second image or images IMG²ᵢ are processed to obtain a digital signature SIG_{Oi} for this object OBJᵢ based on the surface region RSᵢ of this object.

In the embodiment described here, this processing is done by the server SRV which receives the images IMG²ᵢ of the camera CAM1. In a variant, when the second images IMG²ᵢ are acquired by the device USD of an operator, this processing can be carried out by this device or sent by this device to the server SRV for processing.

For one and the same object OBJᵢ, the processing of the first image IMG¹ᵢ (step E30) or of the second image IMG²ᵢ (step E70) makes it possible to obtain the same digital signature SIG_{Oi}, or a digital signature similar enough to be considered as equivalent, since it corresponds to the same object.

In the embodiment of FIG. 7(c), a camera CAM2 past which the conveyor belt TR travels obtains (step E80) the unique identifier ID_{CONT} of the box CONT (grouping unit) by reading the QR code disposed on the outer surface of the box, for example on the side.

The steps E70 and E80 may be carried out in parallel.

The cameras CAM, CAM1 and CAM2 may be made of a single camera or different cameras.

In a variant, the operator U1 (or another operator) uses a user device USD to obtain the unique identifier ID_{CONT} of the grouping unit and can transmit it to the server SRV via the communication module COM.

In the embodiment described here, the digital signatures SIG_{Oi} computed in the step E70 and the unique identifier ID_{CONT} obtained in the step E80 are obtained by the server SRV via the network NET.

In the embodiment described here, during a step E90, the server SRV obtains, in the first database BD1, a datum Dᵢ associated with each of the digital signatures SIG_{Oi} computed in step E70.

This datum Dᵢ can for example be the item of information of information INFO_{Oi} recorded in the first database BD1 in the step E40. Thus, in this example, the server SRV obtains the bar code INFO_{Oi} of each of the bottles contained in the box.

Alternatively, this datum can for example be the index IND of the recording including the digital signature SIG_{Oi}. This index INDᵢ can allow the server SRV to then obtain the item of information INFO_{Oi} associated with the object OBJᵢ.

In a variant, these data Dᵢ can be obtained by the device USD of an operator if the latter is able to access the first database BD1 via the network NET by means of its communication module COM, or to access a replica of this database, hosted for example in a cloud network.

In the embodiment described here, the server SRV records (step E100) in a second database BD2, the datum Dᵢ (index INDᵢ and/or item of information INFO_{Oi}) and/or the digital signature SIG_{Oi} associated with each object OBJ grouped into the box CONT (grouping unit) with the unique identifier ID_{CONT} of this box.

FIG. 8 shows an example of a second database BD2. In this example, the second database BD2 includes for each grouping unit CONT, the identifier ID_{CONT} of this grouping unit, associated with the items of information INFO_{Oi} of the objects grouped into this grouping unit. In the example described here, this second database may include the identifier ID_{CONT} of a box and the bar codes INFO_{Oi} of the bottles grouped into the box.

As shown in FIG. 9, the first and second databases may be one and the same database BD.

FIG. 10 shows in the form of a flow chart the main steps of an object tracking method in accordance with a particular embodiment of the invention.

It is assumed in this example that an operator wishes to track or reconstitute the itinerary of an object, for example a bottle OBJᵢ.

During a step F10, the operator obtains either the item of information INFO_{Oi} associated with this object or a digital signature of the surface region RSi of this object. This step is identical to the steps E10 to E30 described previously.

For example, the operator uses his device USD to read the bar code INFO_{Oi} present on the bottom part of the bottle OBJᵢ or to acquire an image IMG³ᵢ of the surface region RSᵢ of this object, the digital signature SIG_{Oi} being obtained by processing this image with the image-processing module TIM.

During a step F20, the operator uses his device USD to access the second database BD2 and obtain the unique identifier ID_{CONT} of the grouping unit in which this bottle has been transported by means of the datum Dᵢ and/or the digital signature SIG_{Oi}.

During a step F30, the operator accesses an information system including items of tracking information of the grouping unit CONT of identifier ID_{CONT}.

Such information systems are known. They include for example:
items of information relating to the location of the grouping unit CONT at different stages of its transportation, for example the different routes taken and/or the different sorting, storage and forwarding stations through which it has travelled, a history of the places and dates of storage or transit, a history of the logistical operations performed.
   items of information relating to condition data of this box (temperature, humidity),
   items of information relating to individuals who have handled the box (for example the identifier of a terminal used by these individuals during handling).

These items of tracking information of the grouping unit CONT advantageously make it possible to track the object OBJ, since the latter was present in this grouping unit CONT.

A tracking system ST in accordance with a particular embodiment is shown in FIG. 3. It includes:
a module BRC for obtaining an item of information INFO_{Oi} associated with an object OBJᵢ, for example a bar code and/or QR code reader;
a module for obtaining a digital signature SIG_{Oi} for this object OBJᵢ based on a surface region RSᵢ of this object. This module may comprise an image-acquiring module ACQ and an image-processing module TIM as described previously;
a module CBD for obtaining, in a memory BD2 filled by the associating step of a grouping method as previously described, an identifier ID_{CONT} of a grouping unit associated with the datum Dᵢ (the item of information INFO_{Oi} associated with this object OBJᵢ and/or the index INDᵢ) and/or with the digital signature SIG_{Oi} for this object OBJᵢ. This module CBD is for example a client software program configured to access the database CBD; and
a module M30 for tracking a grouping unit CONT and/or the object OBJᵢ, for example a module for accessing an information system as mentioned above.

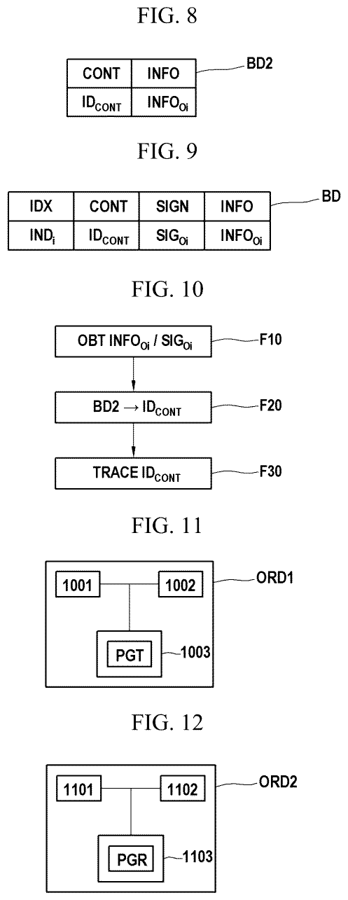

In an embodiment, this tracking system is a computer ORD1, the hardware architecture of which is shown on FIG. 11. This computer includes:
a processing unit or processor 1001, or CPU, intended to load instructions into the memory, execute them, and carry out operations;
a set of memories, including a volatile memory 1002, or RAM used to execute code instructions, storage variables etc., and a storage memory 1003 of EEPROM type. In particular, the storage memory 1003 is arranged to store a computer program PGT comprising instructions which, when the program is executed by a computer, lead the latter to implement the steps of a method for grouping objects as mentioned above.

The user device USD described with reference to FIG. 3 is an example of a system for grouping objects in accordance with an embodiment of the invention. In an embodiment, this grouping system is a computer ORD2, the hardware architecture of which is shown in FIG. 12. This computer includes:
a processing unit or processor 1101, or CPU, intended to load instructions into the memory, to execute them, and to carry out operations;
a set of memories, including a volatile memory 1102, or RAM used to execute code instructions, storage variables etc., and a storage memory 1103 of EEPROM type. In particular, the storage memory 1103 is arranged to store a computer program PGR comprising instructions which, when the program is executed by a computer, lead it to implement the steps of a method for grouping objects as mentioned above.

Another example of the system for grouping objects in accordance with the invention is a system distributed in part on a user device USD and on a server SRV. For example, in this system:
the image-acquiring module ACQ and the module BRC for obtaining a single identifier of a grouping unit are modules of the user device USD; and
the image-processing module TIM, the module CBD for obtaining data in the first database and associating data in the second database are modules of the server SRV.

1. A method for grouping a plurality of objects into a grouping unit, said method including the following steps:
acquiring at least one image, at least one region of a surface of each of said plurality of objects being represented in said at least one image;
processing said at least one image to obtain, for each of said plurality of objects, a digital signature for each object based on said at least one region of each object;
obtaining a unique identifier for said grouping unit;
obtaining, for each of said plurality of objects, a datum associated with each object in a first memory based on the digital signature of each object; and
associating, in a second memory, the datum and/or the digital signature associated with each object with the unique identifier of said grouping unit.

2. The grouping method of claim 1, wherein said datum associated with an object is an item of information associated with said object, said method further including, for each of said objects, the following steps:
obtaining the item of information associated with said object; and
recording this said item of information in association with the digital signature of said object in the first memory.

3. The grouping method of claim 2, wherein for at least one of said objects, the item of information associated with the at least one of said objects is present on the at least one of said objects.

4. The grouping method of claim 2, wherein for at least one of said objects, the item of information associated with the at least one of said objects is a unique identifier associated with the at least one of said objects.

5. The grouping method of claim 1, wherein for at least one of said objects, the surface region is visible when said at least one of said objects is in said grouping unit.

6. The grouping method of claim 1, wherein the first memory or the second memory is a database.

7. The grouping method of claim 6, wherein said first memory and said second memory are one and the same database.

8. The grouping method of claim 1, wherein the grouping unit is a container of said plurality of objects, an item of transportation equipment or an area for the storage of said plurality of objects.

9. The grouping method of claim 1, wherein said digital signature of each object is representative of the material, texture or color of said region of the surface of each object.

10. The grouping method of claim 1, including a step of grouping said plurality of objects into said grouping unit.

11. The grouping method of claim 10, wherein for at least one of said objects, an item of information (INFO_{Oi}) associated with the at least one of said objects and present on the at least one of said objects is at least partially masked by said grouping unit.

12. A method for tracking at least one object, said method including the following steps:
obtaining an item of information associated with the at least one object or a digital signature for the at least one object based on a surface region of the at least one object;
obtaining, in the second memory filled by the associating step of the grouping method of claim 1, an identifier of a grouping unit associated with said item of information associated with the at least one object or with the digital signature for the at least one object; and
tracking said grouping unit.

13. The tracking method of claim 12, said method further including the following steps:
acquiring at least one image representing at least one region of a surface of the at least one object; and
processing said at least one image to obtain the digital signature representative of the at least one object based on said at least one region of the surface of the at least one object represented in said at least one image.

14. A system for grouping a plurality of objects into a grouping unit, said system including:
a module for acquiring at least one image, at least one region of a surface of each of said plurality of objects being represented in said at least one image;
a module for processing said at least one image to obtain, for each of said plurality of objects, a digital signature for each object based on said at least one region of each object;
a module for obtaining a unique identifier for said grouping unit;
a module for obtaining, for each of said plurality of objects, a datum associated with each object in a first memory based on the digital signature of each object; and
a module for associating, in a second memory, the datum or the digital signature associated with each object with the unique identifier of said grouping unit.

15. A system for tracking at least one object, said system including:
a module for obtaining an item of information associated with the at least one object or a module for obtaining a digital signature for the at least one object based on a surface region of the at least one object;
a module for obtaining, in the second memory filled by the associating step of the grouping method of claim 1, an identifier of a grouping unit associated with said item of information associated with the at least one object or with the digital signature for the at least one object; and
a module for tracking said grouping unit.

16. A non-transitory medium comprising a computer program comprising instructions which, when the program is executed by a computer, cause the computer to perform a method for grouping a plurality of objects into a grouping unit, the method comprising:
acquiring at least one image, at least one region of a surface of each of said plurality of objects being represented in said at least one image;
processing said at least one image to obtain, for each of said plurality of objects, a digital signature for each object based on said at least one region of each object;
obtaining a unique identifier for said grouping unit;
obtaining, for each of said plurality of objects, a datum associated with each object in a first memory based on the digital signature of each object; and
associating, in a second memory, the datum or the digital signature associated with each object with the unique identifier of said grouping unit.

17. A non-transitory medium comprising a computer program comprising instructions which, when the program is executed by a computer, cause the computer to perform a method for tracking at least one object, the method comprising:
obtaining an item of information associated with the at least one object or a digital signature for the at least one object based on a surface region of the at least one object;
obtaining an identifier of a grouping unit associated with said item of information associated with the at least one object or with the digital signature for the at least one object, wherein the identifier was previously associated with a datum or with the digital signature; and
tracking said grouping unit.

18. (canceled)
